(19) United States
(12) Patent Application Publication
(10) Pub. No.: US 2022/0397018 A1
(43) Pub. Date: Dec. 15, 2022

(54) BALL VALVE, METHOD, AND SYSTEM

(71) Applicant: James Smith, Manvel, TX (US)

(72) Inventor: James Smith, Manvel, TX (US)

(73) Assignee: Baker Hughes Oilfield Operations LLC, Houston, TX (US)

(21) Appl. No.: 17/346,635

(22) Filed: Jun. 14, 2021

(51) Int. Cl. E21B 34/14; F16K 5/06; F16K 5/20

(52) U.S. Cl. CPC E21B 34/14; F16K 5/0605; F16K 5/0647; F16K 5/0689; F16K 5/201; E21B 2200/04

(57) ABSTRACT

A ball valve including a ball defining a bore therein, and a trunnion arm articulated with the ball via a trunnion, the trunnion arm disposed on a resilient member allowing resilient movement of the trunnion arm pursuant to load on the ball.

### BACKGROUND

In the resource recovery and fluid sequestration industries, ball valves are used for flow control and shut off for a myriad of duties. While common valves are generally effective, they do suffer from load induced wear and/or higher torque requirements for activation when under pressure. The art would well receive alternative configurations that avoid the issues presented in the prior art.

### SUMMARY

An embodiment of a ball valve including a ball defining a bore therein, and a trunnion arm articulated with the ball via a trunnion, the trunnion arm disposed on a resilient member allowing resilient movement of the trunnion arm pursuant to load on the ball.

### BRIEF DESCRIPTION OF THE DRAWINGS

The following descriptions should not be considered limiting in any way. With reference to the accompanying drawings, like elements are numbered alike:

FIG. 1 is a schematic cross section view of a ball valve as disclosed herein disposed in a portion of a wellbore tool;

FIG. 2 is a perspective view of a variation of the valve shown in FIG. 1 wherein the trunnion arms are one piece; and

FIG. 3 is a wellbore system including the ball valve disclosed herein.

### DETAILED DESCRIPTION

A detailed description of one or more embodiments of the disclosed apparatus and method are presented herein by way of exemplification and not limitation with reference to the Figures.

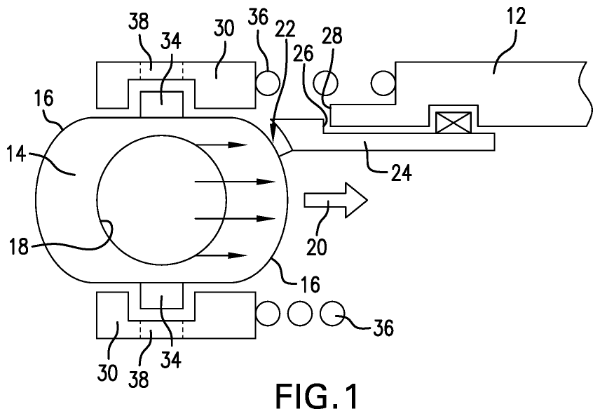

Referring to FIG. 1, a cross section view of a ball valve 10 disposed in a wellbore tool 12 (only a portion shown) is illustrated. The ball valve 10 comprises a ball 14 having a surface 16 (which may or may not be a seal surface in various embodiments) and a bore 18. The ball 14 is rotatable by 90 degrees to a fully open position and 90 degrees in the opposite direction to a fully closed position. In FIG. 1, the ball 14 is illustrated in the closed position with the bore 18 oriented cross ways from the axial flow path 20 though tool 12. The surface 16 of the ball 14 is contacted/supported by a sleeve 24, which may in some embodiments include a seal 22. The sleeve 24 includes a shoulder 26. In lower load conditions, the shoulder 26 is spaced from a buttress 28 of the tool 12 as illustrated but under higher loads on the ball 14, the shoulder 26 makes contact with the buttress 28 which then bears some of the load on the valve 10. The buttress 28 may be a surface of a housing, sub, nut, or other structure of the tool 12.

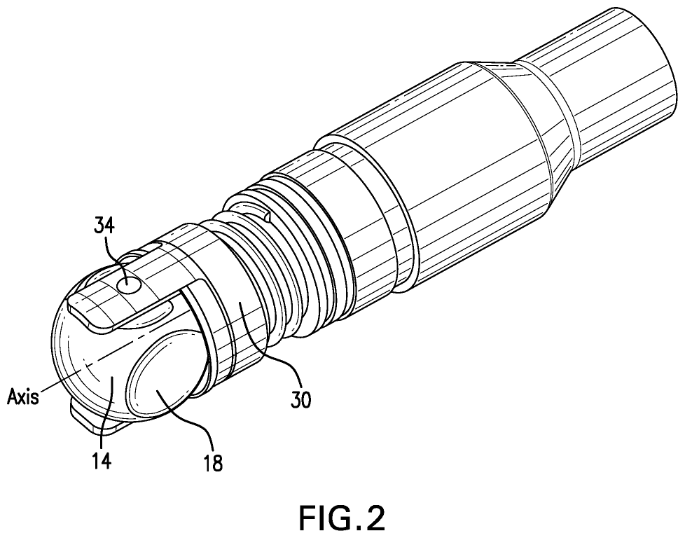

The ball 14 is maintained in position by trunnion arms 30, which may be separate structures or a single structure in various embodiments. One example of the trunnion arms 30 being a single structure is illustrated in FIG. 2. The trunnion arms 30 capture the ball 14 with trunnions 34. It is to be appreciated that the trunnions 34 may be part of the ball 14, may be part of the trunnions arms 30 or may be independent of both and merely may be received in an aperture of the ball 14 and an opening 38 of the trunnion arms 30. The trunnions 34 may also be inserted into the ball 14 through the trunnion arms 30 while they are in place.

Trunnion arms 30 are mounted to a resilient member 36 which may be a coil spring, cone spring, leaf springs etc., which may comprise metal, plastic, rubber, etc. In other words, the trunnion arms 30 are mounted to the tool 12 in a way that allows them to move under load on the ball 14. The movement allows for the shoulder 26 to land on buttress 28. This takes load off trunnions 34 and instead allows for sharing of the load between trunnions 34 and seal 22.

The ball valve 10 allows for low torque activation while also increasing reliability and longevity.

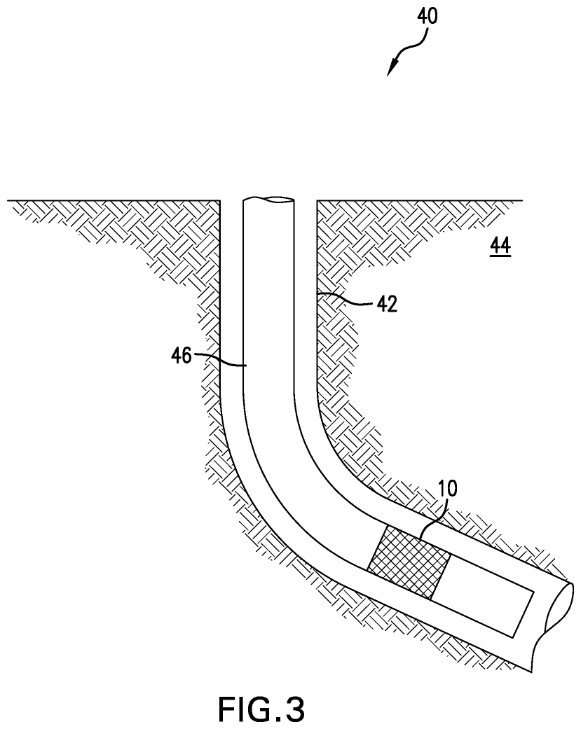

Referring to FIG. 3, a wellbore system 40 comprises a borehole 42 in a subsurface formation 44. A string 46 is disposed in the borehole 42. A ball valve 10 is disposed within or as a part of the string 46.

Set forth below are some embodiments of the foregoing disclosure:

Embodiment 1: A ball valve including a ball defining a bore therein, and a trunnion arm articulated with the ball via a trunnion, the trunnion arm disposed on a resilient member allowing resilient movement of the trunnion arm pursuant to load on the ball.

Embodiment 2: The valve as in any prior embodiment, further including a sleeve in supportive contact with a surface of the ball.

Embodiment 3: The valve as in any prior embodiment, further including a seal in contact with a seal surface of the ball, the seal supported by a sleeve.

Embodiment 4: The valve as in any prior embodiment, wherein the sleeve includes a shoulder.

Embodiment 5: The valve as in any prior embodiment, wherein the shoulder is spaced from a buttress.

Embodiment 6: The valve as in any prior embodiment, wherein the buttress is part of a tool.

Embodiment 7: The valve as in any prior embodiment, wherein the resilient member extends from the trunnion to a tool.

Embodiment 8: The valve as in any prior embodiment, wherein the trunnion arm is two trunnion arms.

Embodiment 9: The valve as in any prior embodiment, wherein the trunnion arms are one piece.

Embodiment 10: The valve as in any prior embodiment, wherein the trunnion arm includes an opening through which a trunnion may be engaged with the ball.

Embodiment 11: A method for controlling flow including closing a ball as in any prior embodiment, and absorbing load on the ball with the resilient member.

Embodiment 12: The method as in any prior embodiment, further including bringing a shoulder of a seal support sleeve into contact with a buttress of a housing and sharing load on the ball between the trunnion arms and the seal support sleeve.

Embodiment 13: A wellbore tool including a housing, and a valve as in any prior embodiment.

Embodiment 14: A wellbore system including a borehole in a subsurface formation, a string disposed in the borehole, and a valve as in any prior embodiment, disposed within or as a part of the string.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% or 5%, or 2% of a given value.

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A ball valve comprising:
a ball defining a bore therein; and
a trunnion arm articulated with the ball via a trunnion, the trunnion arm disposed on a resilient member allowing resilient movement of the trunnion arm pursuant to load on the ball.

2. The valve as claimed in claim 1 further including a sleeve in supportive contact with a surface of the ball.

3. The valve as claimed in claim 1 further including a seal in contact with a seal surface of the ball, the seal supported by a sleeve.

4. The valve as claimed in claim 3 wherein the sleeve includes a shoulder.

5. The valve as claimed in claim 4 wherein the shoulder is spaced from a buttress.

6. The valve as claimed in claim 5 wherein the buttress is part of a tool.

7. The valve as claimed in claim 1 wherein the resilient member extends from the trunnion to a tool.

8. The valve as claimed in claim 1 wherein the trunnion arm is two trunnion arms.

9. The valve as claimed in claim 8 wherein the trunnion arms are one piece.

10. The valve as claimed in claim 1 wherein the trunnion arm includes an opening through which a trunnion may be engaged with the ball.

11. A method for controlling flow comprising:
closing a ball as claimed in claim 1; and
absorbing load on the ball with the resilient member.

12. The method as claimed in claim 11 further including bringing a shoulder of a sleeve into contact with a buttress of a housing and sharing load on the ball between the trunnion arms and the sleeve.

13. A wellbore tool comprising:
a housing; and
a valve as claimed in claim 1.

14. A wellbore system comprising:
a borehole in a subsurface formation;
a string disposed in the borehole; and
a valve as claimed in claim 1 disposed within or as a part of the string.
